(19) United States
(12) Patent Application Publication
(10) Pub. No.: US 2018/0072575 A1
(43) Pub. Date: Mar. 15, 2018

(54) NANOPARTICLE SURFACE-MODIFIED CARBONACEOUS MATERIAL AND METHODS FOR PRODUCING SUCH MATERIAL

(71) Applicants: Imerys Graphite & Carbon Switzerland Ltd., Bodie (CH); ETH ZÜRICH, Zürich (CH)

(72) Inventors: Michal GULAS, Malvaglia (CH); Michael E. SPAHR, Bellinzona (CH); Vito Roberto GIAMPIETRO, Winterthur (CH); Phillipp Rudolf VON ROHR, Basel (CH); Vanesse WOOD, Zürlch (CH)

(21) Appl. No.: 15/553,779

(22) PCT Filed: Feb. 26, 2016
(86) PCT No.: PCT/EP2016/054155

§ 371 Date: Aug. 25, 2017

(30) Foreign Application Priority Data
Feb. 27, 2015 (EP) 15157038.9
Mar. 2, 2015 (EP) 15157208.8

(51) Int. Cl. C01B 32/21; H01M 4/36; H01M 10/0525; H01M 4/587

(52) U.S. Cl. CPC C01B 32/21; H01M 4/366; H01M 10/0525; H01M 4/587; C01P 2002/85; H01M 2004/027; C01P 2006/12; C01P 2004/51; C01P 2006/40; C01P 2006/11; C01P 2002/60

(57) ABSTRACT

The present disclosure relates to a novel surface-modified carbonaceous material with nanoparticles attached to the surface of said material. The carbonaceous material is for example natural or synthetic graphite, and the nanoparticles are for example in the form of plasma polymers generated in a plasma reactor. The present disclosure also relates to processes for preparing said carbonaceous material and to applications for the same, such as an active material for negative electrodes in lithium-ion batteries. It was found that the deposition of the nanoparticles on the surface of the carbonaceous material leads to significant improvements in terms of its flowability and increases the apparent and/or tap density of the resulting material.

### FIELD OF THE DISCLOSURE

The present disclosure relates to a novel surface-modified carbonaceous, e.g., graphitic, material in particulate form with nanoparticles attached to the surface of said material. It also relates to processes for preparing said carbonaceous material and to applications for the same, for instance, in conductive composite materials such as conductive polymers, or as an active material for negative electrodes in lithium-ion batteries.

### BACKGROUND

Carbonaceous materials such as graphite powders, carbon black or coke are used in a multitude of technical applications. Due to the unique chemical, thermal and conductive properties of carbonaceous materials, they are employed in various technical fields, for example as promising filler (i.e., conductive additive) for thermally and/or electrically conductive polymers and other composite materials (e.g., heat sink materials). The importance of graphite has also increased significantly in the field of lithium ion batteries, where the graphite is used as the active material in negative electrodes of such lithium ion batteries.

Depending on the specific use, unmodified natural or synthetic graphite may exhibit certain disadvantages such as thermal and electrical instability, processability issues (low density, problems with flowability, aggregation, etc.), or mechanical instabilities when employed as a component of composite materials. Attempts have been undertaken to address many of these issues, with varying degrees of success.

For example, problems of low density and stickiness have been solved by the provision of ground, agglomerated, graphite which exhibit a higher density and flowability (due to their increased particle size) yet due to inherent softness “dissolve” into fine particles during compounding with a polymer, as described in WO 2012/020099 to Imerys Carbon & Graphite.

Other ways of modifying the properties of carbonaceous materials include the modification of the surface by an oxidation treatment, wherein the graphite particles are subjected to an oxidative treatment at elevated temperatures (about 800° C.) in order to achieve a more polar surface, as described in detail in WO 2013/149807. This International application describes surface-modification processes for graphitic particles obtainable by either an oxidative treatment or, alternatively, by chemical vapor deposition (CVD) coating, which provides graphite materials having improved surface properties.

Plasma polymerization has emerged as a surface modification technique for metals, polymers and powders. Plasma polymerization is different from conventional polymerization. The polymer formed from plasma polymerization and conventional polymerization generally differs widely in chemical composition, as well as chemical and physical properties, even if the same monomers are used for polymerization. This difference in plasma polymers is the result of the unique reaction mechanism caused by the polymer forming process.

The technique involves electric field bombardment of monomer molecules, thereby creating active monomer species, which then react with the surface to form a film on the substrate. As a result, the surface properties of the substrate change dramatically. By suitable selection of monomers, a substrate can either be made hydrophobic or hydrophilic. Plasma polymerization can be carried out at ambient temperature and does not require any solvents for the process, making it a clean process.

The extension of plasma polymerization as a surface modification technique for fillers like carbon black and silica for application in rubber evolved quite recently. Nah et al., Polym. Int. 51, 510 (2002) reported plasma polymerization on silica and its effect on rubber properties. Akovali and Ukem, Polymer 40, 7417 (1999), Tricas et al., 16^{th} Conference of International Society of Plasma Chemistry, Taormina, Italy (2003), and Tricas et al., Proceedings of the Kautschuk-Herbst-Kolloquium, Hannover Germany, (2004) reported the modification of carbon black by plasma polymerization. The monomers used for the process were acrylic acid, styrene and butadiene. Their findings led to the conclusion that carbon black was modified successfully, with the coating covering all sites on the surface of carbon black. Kang and van Ooij, Proceedings ACS Rubber Div. Fall Meeting, Cincinnati, Paper 67 (2006) also reported on the modification of carbon black by plasma polymerization and concluded that it is possible to manipulate the surface properties.

Sophisticated techniques for depositing nanoparticles on various substrates by plasma assisted chemical vapour deposition have for example been described in WO 2007/036060 A1, assigned to ETH Zürich. However, WO 2007/036060 does not mention graphite or other carbonaceous particles as possible substrates for this method.

WO 2012/028695 (FUNDP Namur et al., BE) discloses a method for forming and depositing nanoparticles on nanoscopic and microscopic substrates, such as carbon nanotubes, or porous substrates. In WO 2012/028695, the method is a two-step process wherein the core particles or porous 3-dimensional (flat) substrates are first mixed with liquid or solid precursor compounds outside the reactor. The mixture is subsequently introduced into a plasma reactor and exposed to an electric discharge. The method described in WO 2012/028695 does therefore not allow using gaseous monomers as precursor compounds for the nanoparticles. In any event, WO 2012/028695 does not mention graphite particles as a possible substrate for their method.

Flowability issues are particularly prevalent for non-spherical particles, for example for platy particles, such as non-modified (i.e. flaky) natural graphite. Due to their shape and adhesion forces, the particles stick together giving rise to problems with respect to the processing, dosing, and the dispersion of these particles in thermoplastic and thermosetting matrices, as well as liquids or metal particles and other materials. Attempts have been made to improve the flowability of such plate-like particles such as graphite. Typical measures such as grinding or converting the particles into spherical graphite typically lead to a significant increase of the electrical and thermal resistivity as well as lubricity in the matrices that can be explained by the change of the particle shape.

Having regard to the prior art discussed above, it is therefore an object of the invention to provide new ways to improve the flowability of carbonaceous materials in particulate form, especially particles with non-spherical, e.g. platy morphology, without substantively changing the particle shape. Accordingly, providing particulate carbonaceous materials that are on the one hand characterized by excellent thermal, electrical and mechanical properties, and which on the other hand show excellent processability, such as flowability and bulk density, thereby yielding high dosing accuracy and excellent homogeneity when employed as part of composite materials is another object of the present invention.

### SUMMARY

The present inventors have developed processes for preparing new, advantageous carbonaceous materials in particulate form which solve many of the problems associated with carbonaceous materials known in the art.

Thus, in a first aspect of the present disclosure, a surface-modified carbonaceous material in particulate form is provided which comprises a carbonaceous core and nanoparticles attached to (e.g., grown onto or growth on) the surface of the carbonaceous particles. The nanoparticles may be plasma-deposited nanoparticles. For the sake of brevity, the specific surface modification described herein is referred to as “NPSM” (nanoparticle-surface-modification”), and the resulting carbonaceous materials in particulate form are abbreviated with NPSM carbonaceous material (or NPSM carbonaceous particles), e.g. NPSM graphite or NPSM carbon black.

Another related aspect of this disclosure therefore relates to a surface-modified carbonaceous material in particulate form which is obtainable by a process as described herein.

Yet another aspect of the disclosure relates to the use of said surface-modified material in preparing downstream embodiments, such as a negative electrode of a lithium ion battery comprising said surface-modified carbonaceous material, or a lithium ion battery comprising said surface-modified carbonaceous material in the negative electrode of the battery. Accordingly, such downstream products, including composite materials comprising the surface-modified carbonaceous material as described herein, conductive polymers comprising said surface-modified carbonaceous materials, dispersions comprising said surface-modified carbonaceous materials, negative electrodes of a lithium ion battery comprising said surface-modified carbonaceous material, as well as lithium ion batteries comprising said surface-modified carbonaceous material in the negative electrode of the battery are further aspects of the present disclosure.

Processes for preparing the surface-modified carbonaceous materials in particulate form as described herein represent another aspect of the present disclosure. These processes comprise modifying the surface of carbonaceous, e.g., graphitic, particles by attaching nanoparticles to the surface of the carbonaceous particles. In certain embodiments, the generation and attachment/deposition of the nanoparticles on the surface of the carbonaceous particles is achieved by plasma polymerization of a suitable monomer, e.g. hydrocarbons such as acetylene, or silicon compounds such as hexamethyldisiloxane (HMDSO), in a suitable reactor, e.g. a “plasma reactor”.

Given that the novel NPSM carbonaceous materials described herein possess advantageous properties, the present disclosure further relates, in another aspect, to methods for improving the flowability, for increasing the tap density, and for increasing the dosing accuracy of a given carbonaceous, e.g. graphitic, material in particulate form. These methods involve the surface-modification of said carbonaceous materials according to any of the processes described herein.

In yet another aspect, the present disclosure relates to methods for providing a pre-passivation layer on the surface of a negative electrode active material comprising natural or synthetic graphite, which comprise the modification of the surface of said carbonaceous material in particulate form according to any of the processes described herein. In a related aspect, the present disclosure also provides a method for improving the irreversible capacity of a lithium ion battery, which comprises employing a NPSM carbonaceous material in particulate form as described herein as an active material in the negative electrode of the battery.

Further aspects of the present disclosure relate to surface-modified carbonaceous materials in particulate form, wherein the surface-modified carbonaceous particles comprise a carbonaceous core and nanoparticles attached to the surface of the carbonaceous particles, and further
(i) wherein the nanoparticles on the surface of the carbonaceous particle are plasma-deposited nanoparticles; and/or
(ii) wherein the nanoparticles on the surface of the carbonaceous particle are in the form of a polymer, for instance a plasma polymer; and/or
(iii) wherein the surface-modified carbonaceous material in particulate form has a flowability, expressed by the flow-function coefficient (hereinafter referred to as the flowability factor ff_{c}) of at least 3.5, for example at least 4.0, 5.0, 6.0, 7.0, 8.0, 9.0 or 10.0; and/or
(iv) wherein the surface-modified carbonaceous material in particulate form has a flowability factor ff_{c} that is greater than that of the carbonaceous particles being devoid of said plasma-deposited nanoparticles, for instance wherein the carbonaceous material comprising plasma-deposited nanoparticles has a flowability factor that is at least about 100% higher, for instance at least about 150% or 200% higher than the flowability factor of the carbonaceous particles being devoid of said plasma-deposited nanoparticles on the surface of the carbon particles; and/or
(v) wherein the surface-modified carbonaceous material in particulate form has an apparent (Scott) and/or tap density that is increased by about 10%, for instance at least about 20%, 30%, 40%, 50% compared to the respective density of the carbonaceous particles being devoid of said nanoparticles attached to the surface of the carbon particles.

Yet another aspect of this invention relates to compositions comprising the nanoparticle surface-modified carbonaceous particles described herein in a mixture together with other carbonaceous (including graphite, carbon black, coke, and the like) or non-carbonaceous materials (e.g., metallic materials) in particulate form, or combinations thereof.

### BRIEF DESCRIPTION OF THE DRAWINGS

FIG. 1a shows a schematic RF plasma (glow-discharge) reactor for the processing of carbonaceous particles such as graphite.

FIG. 1b depicts a schematic view of a liquid-monomer supply unit for plasma reactors.

FIG. 2 illustrates the principles of the uni-axial compression test used to determine the flowability factor ff (adapted from: D. Schulze, Powders and bulk solids-behavior, characterization, storage and flow, Springer, Germany, 2008). The lower panel shows a graph illustrating the ratio of σc vs. σ1 yielding the flowability factor ff.

FIG. 3 shows the shear cell of a ring shear tester (RST-XS Schulze Schüttguttechnik, Germany) employed for determining the flowability factor for the various carbonaceous materials described herein.

FIG. 4 shows a general scheme and set up for X-Ray photoelectron spectrometry (XPS).

FIG. 5 shows scanning electron microscopy (SEM) pictures of an unmodified synthetic graphite starting material (termed SG-1), and of various plasma-deposited nanoparticle surface-modified graphites prepared in a plasma reactor according to the present disclosure.

FIG. 6 shows the results of electrical resistivity measurements of Nanoparticle Surface-Modified Graphite powder prepared according to the present disclosure (plasma-deposition) and of control samples (corresponding untreated synthetic graphite powder).

FIG. 7 illustrates the results of measuring the pressed density versus the applied pressure for Nanoparticle Surface-Modified Graphite powders (by Plasma-Deposition) and Control Samples (untreated material).

### DETAILED DESCRIPTION OF THE INVENTION

The present inventors have studied the effects of depositing nanosized (e.g., <100 nm) particles onto the surface of carbonaceous materials such as graphite or carbon black.

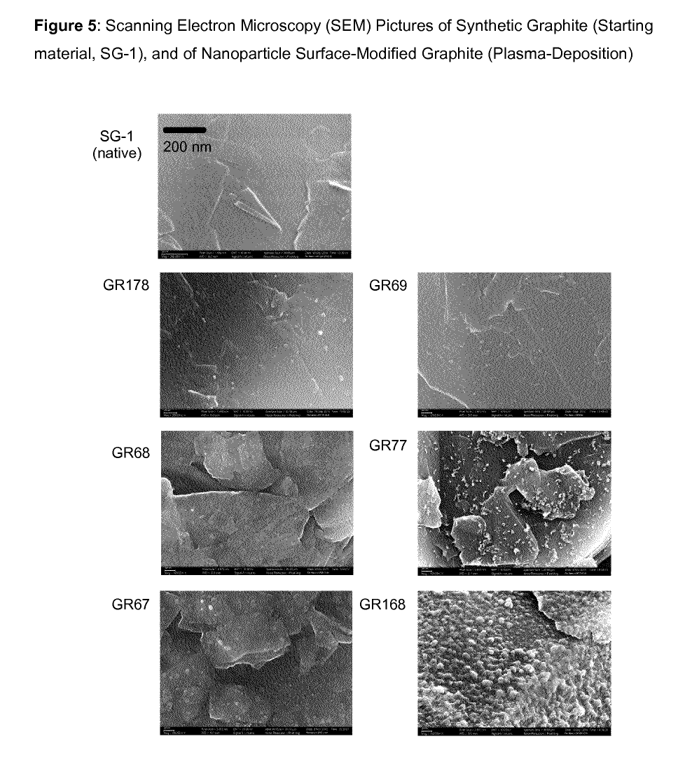

The nanoparticles in some embodiments form a non-continuous layer on the surface of the carbon particles, i.e. they cannot be qualified as a full, continuous coating of said particles (see for example the samples shown in FIG. 5), although it will be understood that in certain embodiments the nanoparticles may well be connected to each other by plasma polymer “bridges”. In any event, the surface of the nanoparticle surface-modified carbonaceous particles is typically characterized by a very low uniformity, in contrast to other coating methods which lead to highly uniform coatings on the surface of the carbon particles.

In other embodiments, the density of the nanoparticles may be so high that the attached nanoparticles practically form a continuous layer or film on the surface of the carbonaceous material.

It was found that such a modification of the particles leads to a product which has excellent flowability (essentially the modified powder was in most cases “free flowing”, i.e. with a flowability factor of >8 or even >10) and which does not show any significant agglomeration tendencies.

These properties are particularly advantageous for a convenient, as well as precise and reproducible processing of the material, e.g. when used as a (conductive) filler in polymers or other composite compounds. Moreover, a significant increase of the apparent and tap density could be observed for the nanoparticle-surface-modified carbon particles prepared and described herein. In contrast thereto, the absolute density (“xylene density”) of the modified particulate material was found to be very slightly decreased, but not to any significant degree.

Increased flowability and higher apparent and/or tapped density are advantageous because they lead to an improved dosing accuracy, which is particularly important in industrial processes, for example when mixing the surface-modified carbonaceous powder with a polymer (typically done in an extruder or compounder) to prepare conductive polymer composite materials. The high flowability and apparent lack of agglomeration/clumping of the carbon particles also leads to an excellent distribution of the particles within the polymer matrix yielding a highly homogenous product.

It will be appreciated that with such a homogenous distribution of the carbon, e.g. graphite, particles, in the polymer matrix a desired level of electrical conductivity can be achieved with lower amounts of such carbon particles. Similarly, the percolation effect (which is at least in certain products or applications desired or even required) will be observed at lower concentrations of said surface-modified carbon particles in the matrix, which may not only be advantageous in terms of costs (less graphite is needed), but which will also show a positive effect on certain mechanical properties of the composite materials (a too high content of graphite may in contrast be undesirably because it may cause certain, mainly mechanical/physical, instabilities such as brittleness in the composite materials).

Also, without wishing to be bound by any theory, it is believed that the nanoparticles attached to the surface of the graphite particles cover at least partially the basal planes (which may be inert and/or hydrophobic as compared to prismatic sites that may be more reactive to functional groups) and thus may make them more reactive (rather than inert), e.g., as interaction centers that may be wetted by a matrix material, when present in a matrix material (e.g., a polymer). In other words, it is believed that there is more interaction between the surface modified graphite particles and the polymer, resulting, inter alia, in a better polymer tensile strength, comparable to how carbon black interacts in rubber.

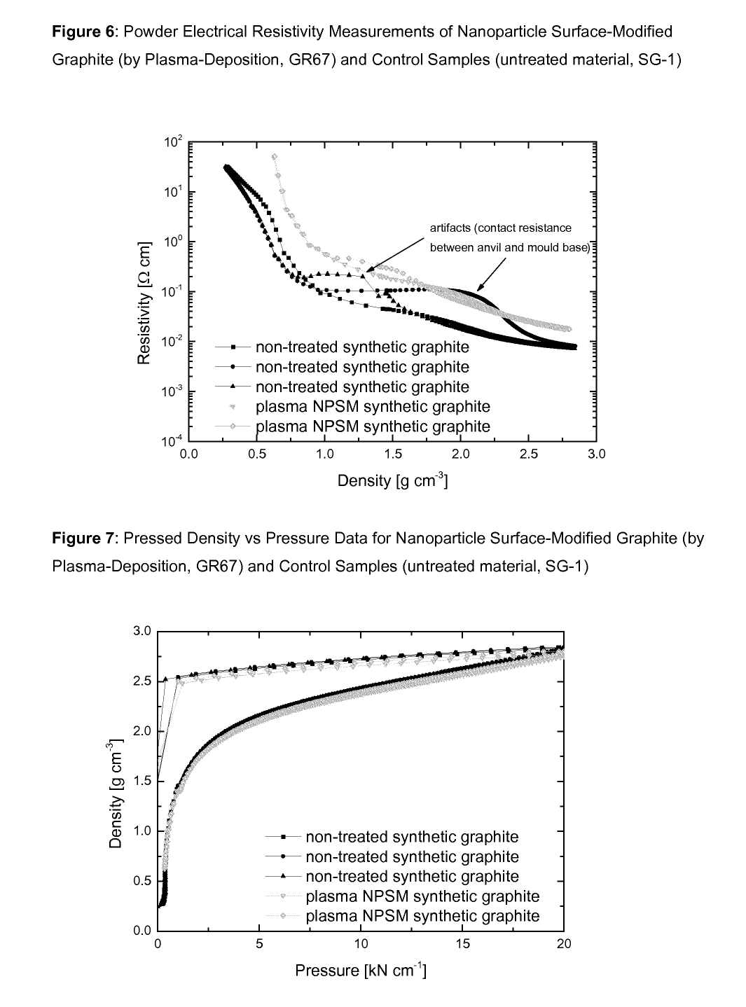

It was observed that the nanoparticle surface modified carbonaceous particles, particularly if the nanoparticles consist essentially of carbon atoms, exhibit a slightly decreased electrical conductivity compared to the untreated material (cf. FIG. 6), which may at least in certain applications be desirable, e.g. where the material is primarily used for increasing the thermal conductivity of a polymer or other composite material.

### Nanoparticle Surface-Modified (NPSM) Carbonaceous Material

As mentioned above, the nanoparticle surface-modified (abbreviated “NPSM”) carbonaceous material in particulate form (the “carbonaceous material in particulate form” is alternatively referred to herein as “carbonaceous particles”) according to the present disclosure are comprised of carbonaceous core particles having nanoparticles attached to their surface, thereby forming a non-continuous decoration of the carbonaceous particles (see, for example the SEM pictures shown in FIG. 5).

Nanoparticles may be defined as particles having an average size of <about 100 nm. In some embodiments, the nanoparticles may form so-called nanoclusters, which for the purpose of the present disclosure are defined as aggregated or agglomerated nanoparticles with an average size of below about 1000 nm.

In certain embodiments, the carbonaceous core may comprise materials selected from natural or synthetic graphite, exfoliated graphite, carbon black, petroleum- or coal-based coke, graphene, graphene fiber, nanotubes, including carbon nanotubes, where the nanotubes are single-walled nanotubes (SWNT), multiwalled nanotubes (MWNT), or combinations of these; fullerenes, nanographite, or combinations thereof, optionally together with other non-carbonaceous particles (e.g., metallic particles). In particular embodiments, the carbonaceous core is either natural or synthetic graphite, which may be ground or unground prior to the surface modification. Also included as possible cores are surface-modified carbonaceous materials. For example, suitable core particles include carbonaceous particles coated with amorphous carbon, which can be obtained by pitch-coating, CVD-coating (e.g., those described in WO 2013/149807), or carbonization of organic precursor coatings (e.g., those described in WO 2015/158741), or carbonaceous particles where the surface has been subjected to an oxidation treatment (e.g., those described in WO 2013/149807), or both (e.g. in WO 2016/008951), all of which are incorporated herein by reference to the above-listed WO publications in their entirety.

The core particles may have an average particle size (D₅₀ value as measured by laser diffraction methods as described in the Methods section) of between 1 and 500 μm, or between 2 and 100 μm, or between 3 and 100 μm, or between 5 and 50 μm. It will be appreciated that the size of the carbon core particles is generally independent of the surface-modification by nanoparticles as described herein, and their size is rather selected, or can be tailored, e.g., by grinding/milling, to comply with the intended use or application of the resulting material.

In some embodiments, the carbonaceous core particles have a non-spherical, such as a platy morphology. It was found that the surface-modification process described herein (i.e. the attachment of nanoparticles on the surface of the carbonaceous particles, essentially does not change the morphology of the treated particles. Thus, particles with a platy shape such as graphite will retain its morphology even after the treatment described herein.

In some embodiments, the nanoparticles attached to the surface of the carbonaceous particles comprise one or more of the following elements: carbon, silicon, oxygen, fluorine, hydrogen, tin, titanium, germanium, indium or combinations thereof. For example, in certain embodiments, the nanoparticles may comprise besides the main element, e.g. carbon, also traces of other elements (such as hydrogen or oxygen), as a result of the chosen monomer and the process conditions leading to the formation and deposition of the nanoparticles.

In certain embodiments, the carbonaceous particles comprise more than one, such as two, three, or even four different nanoparticle species on their surface, i.e. the nanoparticles on a given carbonaceous core particle are not uniform in terms of their chemical composition. Alternatively, the nanoparticles attached to the carbonaceous core may all be essentially uniform as regards their chemical composition, but still comprise two, three, four or even more than 4 of the chemical elements listed above.

In some embodiments, the nanoparticles are present on the surface of the carbonaceous particle in the form of a polymer, i.e. a molecular “network” of many repeating subunits. Such polymeric nanoparticles are chemically clearly distinguishable from other forms, such as amorphous carbon, deposited on the surface of carbon particles (e.g. carbon black or graphite) such as graphite. The polymers differ not only in their structure but also in their electrical behavior as such polymers are typically non-conductive, whereas amorphous carbon may exhibit a certain electrical conductivity (even if lower than graphite).

In certain embodiments of this aspect of the invention, the nanoparticles attached to the surface of the carbonaceous particles are in the form of a plasma polymer, i.e. a polymer obtainable in a plasma reactor, as described in more detail below.

The structure and properties of plasma polymers differ to a great extent from those of conventional polymers. First of all, the properties of plasma polymers depends more on the design of the reactor and the chemical and physical properties of the substrate on which the plasma polymer is deposited. By using plasma polymerization with a single monomer and varying the reactor, substrate, and reaction conditions, a variety of polymers can be prepared that each have different physical and chemical properties. Accordingly, it is generally difficult to assign a set of basic characteristics to plasma polymers, though plasma polymers share a few common properties that distinguish plasma polymers from conventional polymers. One very significant difference to conventional polymers is that plasma polymers generally do not contain regular repeating units. In view of the number of different propagating species present at any one time in the plasma reactor, the resultant polymer chains are typically highly branched and randomly terminated, with a high degree of cross-linking (Zang, Z. (2003), Surface Modification by Plasma Polymerization and Application of Plasma Polymers as Biomaterials. Johannes Gutenberg University of Mainz).

Plasma polymers also contain free radicals, with the amount of said free radicals varying between different plasma polymers. The amount is generally dependent on the chemical structure of the monomer. The overall properties of the plasma polymers appear to correlate with the number of free radicals trapped in the polymer (S. Gaur and G. Vergason, Plasma Polymerization: Theory and Practice, 43^{rd} Annual Technical Conference Proceedings—Denver, Apr. 15-20, 2000, pp. 267-271).

Thus, in certain embodiments of this aspect of the disclosure, the nanoparticles attached to the surface of the carbonaceous particles are plasma-deposited nanoparticles. As noted above, the nature of the plasma polymer is governed, inter alia, by the choice of monomer used during said plasma polymerization process. Generally, any monomer that can be used in a plasma polymerization process can be used for producing and depositing the nanoparticles on the surface of the carbonaceous particles.

In some embodiments, the monomer is selected from
(i) hydrocarbons or a mixture of hydrocarbons, optionally having functional groups;
(ii) higher molecular weight organic molecules;
(iii) silicon compounds,
(iv) halogenated carbons, including fluorocarbons
(v) organometallic compounds,
(vi) titanium tetrachloride,
(vii) tin compounds,
(viii) phosphorous compounds,
   or combinations thereof.

The hydrocarbons may be selected from one or more of methane, ethane, ethylene, acetylene, propane, propylene, heavy oil, waste oil, pyrolysis fuel oil, or combinations thereof, while the organic molecules may comprise a vegetable fat such as rapeseed oil. Hydrocarbons may also include functional groups, i.e. oxygen, nitrogen, sulfur atoms may also be present. Halogenated carbon compounds may include chloro-, fluoro, and bromocarbons, including mixed halogencarbons (e.g. fluoro-chlorocarbons). Suitable fluorocarbons include, but are not limited to C₂F₆ or C₃F₈, whereas silicon compounds may beselected from siloxanes and/or silanes, such as Hexamethyldisiloxane (HMDSO), Divinyltetramethyldisiloxane (DVTMDSO), or Triethylsilane (TES), amongst others. Examples of organometallic compounds include titanium(IV) isopropoxide, tetrakis dimethylamido titanium (TDMAT), tetrakis diethylamido titanium (TDEAT), diethylamino titanium (DEAT), dimethylaminotitanium (DMAT). Tin compounds may include tin-containing organic compounds. Titanium tetrachloride may also be used as a monomer in certain embodiments. Exemplary phosphorous compounds include alkylphosphines such as trimethylphosphine, diethylphosphine, or triethylphosphine, and the like.

In some embodiments, the surface-modified carbonaceous material comprising a carbonaceous core and nanoparticles attached to the surface of the carbonaceous particles as described herein may further be coated with amorphous carbon (pitch-coating, CVD-coating, or carbonization of a coating with an organic precursor, e.g. as described above with reference to WO 2015/158741) after the plasma-polymerization. Likewise, in certain embodiments, the surface-modified carbonaceous particles may after plasma-polymerization be subjected to an oxidative surface treatment as described in WO 2013/149807, or a combined amorphous coating and surface oxidation as described in WO 2016/008951.

The surface-modified carbonaceous material comprising a carbonaceous core and nanoparticles attached to the surface of the carbonaceous particles as described herein may in some embodiments be further characterized by one or more of the following properties, alone or in any combination:
(a) a crystallite size L_{c} (L_{c}(002) as measured by XRD) ranging from 1 to 1000 nm, or from 5 to 300 nm, or from 10 to 200 nm, or from 20 to 150 nm;
(b) a crystallite size Lₐ (as measured by Raman spectroscopy) from 1 to 1000 nm, or from 2 to 100 nm, or from 3 to 60 nm, or from 5 to 50 nm;
(c) a ratio of L_{c}/Lₐ, of between 0.1 and 1000, preferably greater than 1.0, 2.5, 5.0, 10.0, or 25, and lower than 50;
(d) a c/2 interlayer distance of between 0.3354 nm and 0.5000 nm, or between about 0.3354 nm and 0.4000 nm;
(e) a BET SSA of between about 0.5 m²/g and 800 m²/g, or between about 1 m²/g and 60 m²/g, or between about 1 m²/g and 20 m²/g;
(f) a particle size distribution (PSD) expressed by a D₉₀ of below about 100 μm, or below about 75 μm, or below about 50 μm; optionally wherein the D₉₀ is between 1 and 100 μm, or between 5 and 75 μm, or between 10 and 50 μm; and/or
(g) the nanoparticles representing from 1 to 50% (w/w) of the surface-modified carbonaceous particles, or from 5 to 20% (w/w) of the surface-modified carbonaceous particles.
(h) an oil absorption number below about 1000 (ml/100 g), below about 200 (ml/100 g), or below about 100 (ml/100 g), or below about 50 (ml/100 g).

The surface-modified carbonaceous material described herein may in certain embodiments be, alternatively or in addition, further characterized by one or more of the following electrochemical properties when used as an active material in a lithium ion electrode as specified below in the Methods section:
(a) an irreversible capacity of below about 20%, or below about 17%, or below about 15%, or below about 13%, or below about 11%, or below about 10%;
(b) a reversible capacity of above about 350 mAh/g, or above about 380 mAh/g, or above about 400 mAh/g, or above about 425 mAh/g, or above about 450 mAh/g; and/or
(c) an improved charge acceptance compared to untreated material (i.e. the same core material without the nanoparticle s attached to the surface) of more than about 5%, or more than about 10%, or more than about 15%, or more than about 20%;

Overall, the surface-modified carbonaceous material described herein is expected to exhibit a favorable cycling stability when used as an active material in negative electrodes of lithium ion batteries in view of the presence of nanosized material on the surface of the particles. Without wishing to be bound by any theory, it is believed that the surface modification improves volume expansion and thus reduces cracking of the electrode employing such a carbonaceous material.

The plasma-deposited nanoparticles in some embodiments consist essentially of carbon, which may, however, include low amounts of hydrogen, and, if functional groups are present in the monomer, also nitrogen, oxygen, sulfur and the like (typically, but not necessarily in the ppm range). Such nanoparticles can be obtained by using hydrocarbon-based compounds, such as acetylene or ethylene, as the monomer source for the plasma polymerization process.

In other embodiments, the plasma-deposited nanoparticles in some embodiments consist essentially of silicon, though they may include low amounts of hydrogen, carbon, nitrogen and oxygen (typically, but not necessarily in the ppm range).

Alternatively, the plasma-deposited nanoparticles comprise two or more different species, caused by the use of more than one type of source monomer. In such embodiments, a first species consists essentially of carbon, optionally with low amounts of hydrogen, nitrogen and/or oxygen, and a second species consists essentially of silicon, optionally with low amounts of hydrogen, carbon, nitrogen, and/or oxygen. For example, excellent results have been achieved when using acetylene and hexamethyldisiloxane (HMDSO) concomitantly as the monomer sources in the plasma polymerization process of the carbonaceous particles, such as synthetic graphite (see Example 1 for more details).

As can be seen form the experimental results (Example 1, Table 1 b, infra), the BET specific surface area (BET SSA) of the NSPM carbonaceous particles is essentially not affected by the deposition of the (mostly spherical) nanoparticles on the surface of the carbonaceous core particles, which is consistent with the surface structure of the particles as shown in the SEM pictures of the surface modified material (cf. FIG. 5). Smaller changes may of course be observed (also depending on the number and size of the nanoparticles on the surface of the core particles), but there is no clear trend discernible that would be caused by the surface modification described herein.

The NPSM carbonaceous material of the present disclosure can in some embodiments be further characterized by various techniques examining the content of certain elements in the (bulk) powder (i.e. an overall content) or, alternatively, on the surface of the particles.

One suitable method for determining the content of certain chemical elements in carbonaceous particles is termed Spark Discharge (in Argon) Optical Emission Spectroscopy (SD(AR) OES). In general, the powder to be examined is pressed into a “tablet”, placed onto the excitation stand of an SDAR OES Simultaneous Emission Spectrometer under an argon atmosphere, and subsequently analyzed examined by an automated routine (see Method section below for more details on the specifics of the methodology) Further details of this analytical method are described, for example, in K. Slickers, Automatic Emission Spectroscopy (1992), Brühl Druck und Presshaus Giessen (Germany).

Thus, in some embodiments where the nanoparticles comprise silicon (e.g. by including silicon compounds as a monomer source in a plasma polymerization process), the NPSM carbonaceous material can be further characterized by a bulk silicon content, as measured by Spark Discharge Optical Emission Spectroscopy (SD-OED), of at least about 0.3 wt %, for example at least about 0.35, 0.40, 0.45 or 0.5 wt %.

For determining the elemental composition and chemical constitution of the surface of the modified carbonaceous materials described herein, an analytical technique termed X-Ray Photoelectron Spectroscopy (XPS) can be used (see Method section below for more details on the specifics of the XPS methodology).

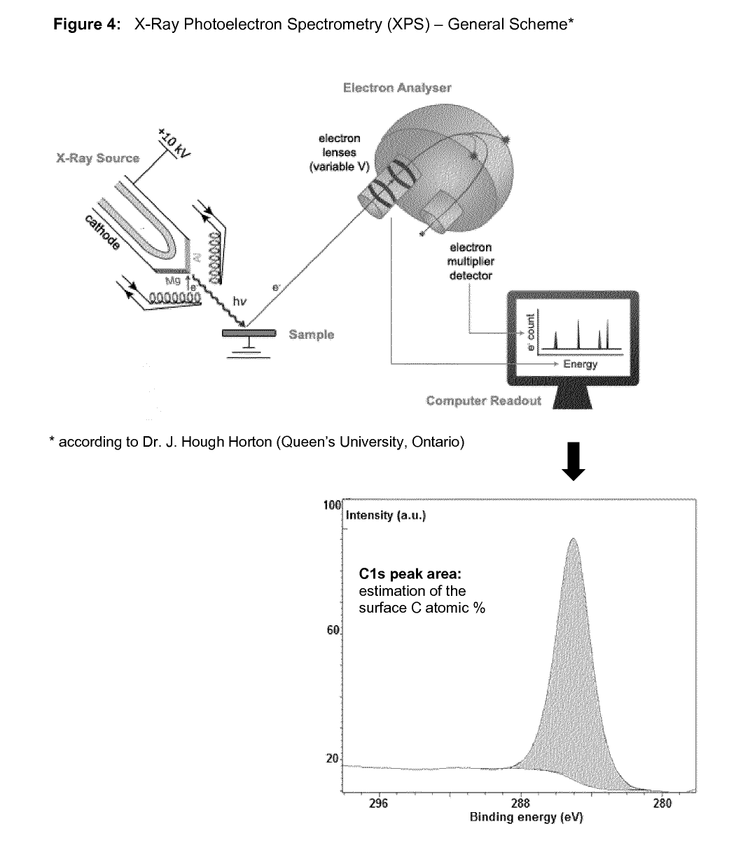

The intensity and kinetic energy of the emitted photoelectrons determined revealed by the electron analyzer give information about the chemical nature of the atoms present on the surface. The quantitative analysis was performed for the C1s signal, the O1s signal and the Si2p3/2 signal by considering the peak areas in the high-resolution spectra, as detailed in the Methods section. For an overview of a typical XPS instrumental setup and measurement see FIG. 4.

In certain embodiments where the nanoparticles comprise silicon (e.g. by including silicon compounds as a monomer source in a plasma polymerization process), the NPSM carbonaceous material can be further characterized by an atomic ratio of silicon to carbon (Si/C) on the surface of the carbonaceous particles, as measured by X-ray photoelectron spectroscopy (XPS) according to the protocol and measurement conditions outlined in the Method section, of at least about 0.25, for example at least about 0.30, 0.35 or 0.40.

In other embodiments, the atomic ratio of oxygen to carbon (O/C) on the surface of the carbonaceous particles, as measured by X-ray photoelectron spectroscopy (XPS), is at least about 0.03, for example at least about 0.04 when the nanoparticles consist essentially of carbon, and is at least about 0.06, for example at least about 0.08, 0.10 or 0.12 when the nanoparticles comprise silicon.

Overall, it has been found that the deposition/attachment of nanoparticles on the surface of the carbonaceous particles leads to an increased concentration of oxygen and, where applicable, silicon atoms on the surface of the particles, and hence also of the overall (bulk) content of these elements in the resulting surface-modified particles.

One major effect observed for the NPSM carbonaceous particles described herein is the remarkable increase of the flowability of these surface-modified carbonaceous particles. In general, the powder flow behavior depends on the balance between gravitational and interparticle forces, namely the Van der Waals attractive forces in case of dry micropowders (I. Zimmermann, M. Ebner, K. Meyer, Z. Phys. Chem., 2004, 218, p. 51). The flow behavior influences powder handling and processing, as cohesive and sticking powders can cause pipe and hopper clogging as well as difficulties in mixing and sieving.

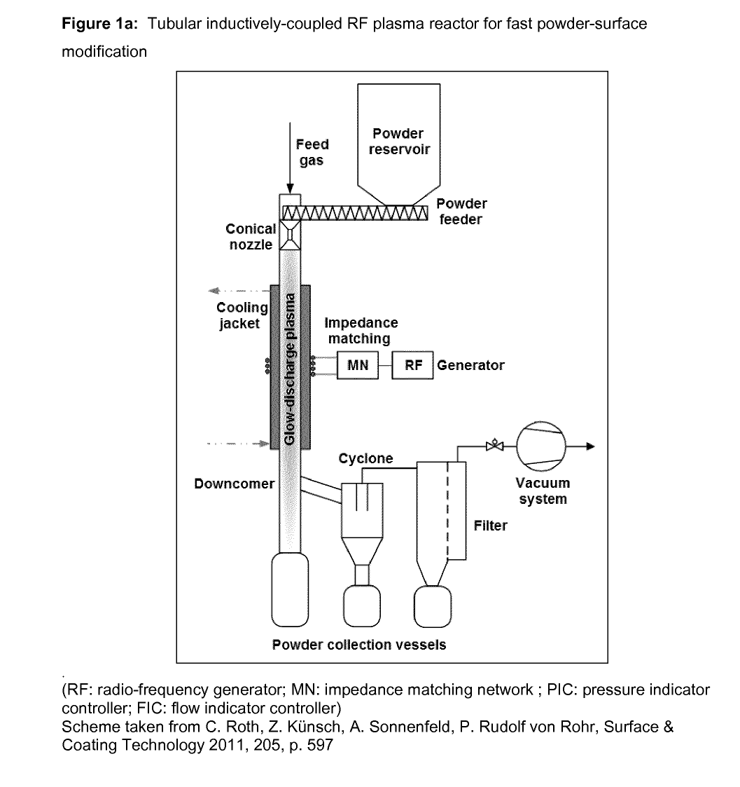

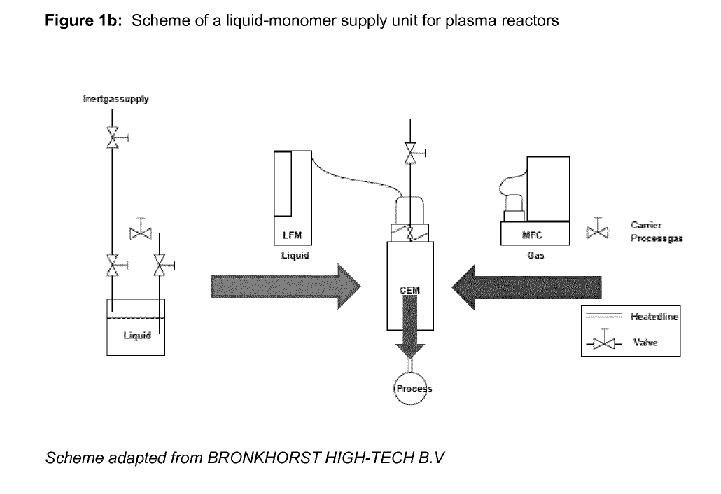

Improvement of powder flow behavior is achieved by depositing nanoparticles forming a non-continuous coating on the surface of the carbonaceous particles as described herein (e.g., by plasma deposition, which can be implemented in a tubular plasma reactor to perform a fast deposition of a non-continuous coating of nanoparticles on the powder particles, see, e.g., FIG. 1).

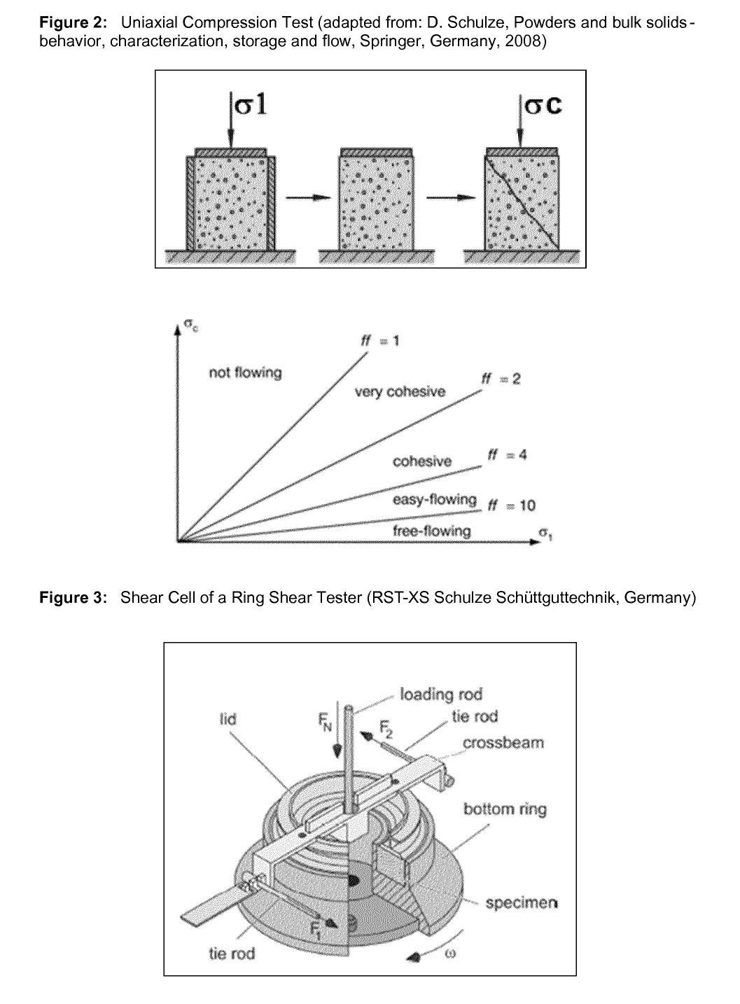

Without wishing to be bound by any theory, it is believed that by roughening the particle surface, the nanoparticles attached/deposited on the surface of the carbon particles diminish the direct interaction of the surfaces of the carbonaceous particles (acting as a “spacer”), thereby improving the powder flow behavior. This improvement in flowability can be quantified by determining the flowability factor (ff_{c}), which is defined as the ratio of the consolidation stress σ1 to the unconfined yield strength σc in an uniaxial compression test (cf. FIG. 2):

$${ff}_{c} = \frac{{σ}_{1}}{{σ}_{c}}$$

For determining the flowability of a given carbonaceous material in particulate form, the powder is totally confined and compressed by the consolidation stress σ₁. After σ₁ is released and the confinement is removed, an increasing stress is applied until the powder breaks apart and flows. This critical stress is σ_{c}, which increases with increasing consolidation stress. The flow function is the relationship between σ₁ and σ_{c} and its slope is the flow function coefficient ff_{c}. The flow behavior is classified as “not flowing” for ff_{c}<1, “very cohesive” for 1<ff_{c}<2, “cohesive” for 2<ff_{c}<4, “easy-flowing” for 4<ff_{c}<10, and as “free-flowing” for 10<ff_{c} 2 (cf. C. Roth, Ph.D. Thesis No. 20812, ETH Zürich, 2012, and D. Schulze, Powders and bulk solids—behavior, characterization, storage and flow, Springer, Germany, 2008).

As noted above, it was observed that the deposition/attachment of the nanoparticles led to a large increase in the flowability of the surface-modified particles. For example, an untreated sample of a synthetic graphite powder (D₅₀ of about 15 μm, D₉₀ of about 30 μm), the flowability factor was around 3.4, while the deposition of nanoparticles on the surface of said graphite powder led to flowability factors above 8, in certain instances even above 10, i.e. the resulting particles were essentially free-flowing (see Example 1, Table 1 b for details).

Hence, in some embodiments of this aspect of the invention, the NPSM carbonaceous particles can be further characterized by having a flowability factor ff of at least 3.5, for example at least 4.0, 5.0, 6.0, 7.0, 8.0, 9.0 or 10.0.

The NPSM carbonaceous particles can, alternatively or additionally, be characterized in terms of their relative increase of the flowability compared to the respective non-modified carbonaceous particles material. In such embodiments, the NPSM carbonaceous particles are characterized by a flowability, expressed by the flowability factor ff_{c}, that is greater than that of the carbonaceous particles being devoid of said nanoparticles on their surface. In some embodiments, the NPSM carbonaceous material in particulate form has a flowability factor f that is at least about 50% higher, for example at least about 100%, 150% or 200% higher than the flowability factor of the carbonaceous particles being devoid of said nanoparticles on the surface of the carbon particles.

Another advantage offered by the NPSM carbonaceous particles described herein is their increased apparent and tapped density which further facilitates the handling of the particles, e.g. when preparing composite materials. Hence, in yet other embodiments, the NPSM carbonaceous particles may be further defined by an increased apparent (Scott) and/or tap density, both in absolute terms as well as compared to the non-modified material. It will be appreciated that the apparent (i.e. Scott) and tap densities are in absolute terms of course strongly dependent on density of the unmodified starting material. Typical Scott densities for untreated graphite materials are between about 0.05 g/cm³ and about 0.7 g/cm³, while typical tap densities of such graphites are in the range of about 0.1 g/cm³ to 1.1 g/cm³. To take one example, the Scott density of a starting graphite material synthetic graphite 1 SG1) was 0.23-0.24 g/cm³, and the graphite after the surface modification (NPSM graphite) exhibited Scott densities in range of 0.25 to 0.4 g/cm³.

In any event, the NPSM carbonaceous material described herein can be further defined by a relative increase in the apparent and tap densities compared to the corresponding non-modified particulate material. In certain embodiments, the NPSM carbonaceous material has a Scott and/or tap density that is increased by at least about 10%, for example at least about 20%, 25%, 30%, 40%, or 50% compared to the respective densities of the carbonaceous particles being devoid of said nanoparticles on their surface.

The absolute density (“xylene density”) of the carbonaceous particles does not change very much after the plasma assisted deposition process. Nevertheless, it was generally observed that the xylene density was very slightly lower after the treatment (possibly because the nanoparticles are typically not comprised of graphitic carbon.

Another advantage associated with the NPSM carbonaceous particles provided herein is that the introduction of new functionalities at the carbonaceous particle surface can be facilitated by choosing an appropriate chemistry of the nanoparticles attached to the carbon particles. In fact, the addition of nanoparticles at the surface of the carbonaceous particles offers an advantageous way to add small particles into graphite or other carbonaceous materials (e.g. silicon and tin containing oxy-polymers). Such an addition may influence the passivation effect of lithium ion battery active materials or even increase the electrochemical capacity if the plasma polymer is electrochemically active.

### Uses of the Surface-Modified Carbonaceous Material

Since the obtained nanoparticle surface-modified carbonaceous materials as defined herein exhibit excellent processing characteristics such as a markedly increased flowability, yet another aspect of the present invention relates to the use of the NPSM carbonaceous particles described herein in downstream applications.

One such use contemplated herein is for preparing (possibly thermally and/or electrically conductive) composite materials, including composite materials with polymers (e.g, thermoplastics or thermosets) that are widely used in applications where the thermal and/or electrical conductivity of the polymer is not sufficient. For instance, the NPSM carbonaceous particles may be used in preparing polymeric heat sink materials. Another example relates to the use of said NPSM carbonaceous particles for preparing a negative electrode material, e.g. in lithium ion batteries. Yet another example relates to the use of the NPSM carbonaceous particles for the preparation of dispersions in liquids (e.g., water, other polar liquids, or solvents, including organic solvents).

Hence, another, related aspect of the present disclosure relates to such downstream composite materials comprising the NPSM carbonaceous particles as described herein, including the above-mentioned composite materials (including polymer composites) and dispersions, as well as negative electrodes or lithium ion batteries.

In these embodiments, the NPSM carbonaceous material is typically present in a weight ratio of 5-99% by weight, or 10 to 85% by weight of the total composition, or 20 to 90% by weight of the total composition, or 30 to 85% by weight of the total composition. In view of the excellent dosing accuracy, flowability and homogenous dispersion achieved within the polymer matrix, it will be appreciated that typically less of the carbonaceous material will be needed for achieving the same level of electrical conductivity.

An electric vehicle, hybrid electric vehicle, or plug-in hybrid electric vehicle which comprises a lithium ion battery, wherein the lithium ion battery comprises the NPSM carbonaceous particles as described herein as an active material in the negative electrode of the battery represents yet another aspect of the present invention.

In yet another aspect, the present invention relates to an energy storage device comprising the NPSM carbonaceous particles according to the present invention.

A further aspect of the present disclosure relates to a carbon brush or a friction pad comprising the NPSM carbonaceous particles as described herein.

### Processes for Preparing the Nanoparticle Surface-Modified Carbonaceous Material

Yet another aspect of the present invention relates to a process for preparing the NPSM carbonaceous material in particulate form as described herein.

The process for making the NPSM carbonaceous material in particulate form as described herein generally comprises the step of attaching nanoparticles to the surface of carbonaceous particles. In certain embodiments, the attachment of the nanoparticles is permanent by forming chemical bonds with the surface of the carbonaceous material.

In principle, the starting material for the process can be any carbonaceous particulate material, such as natural or synthetic graphite, exfoliated graphite, carbon black, petroleum- or coal-based coke, graphene, graphene fiber; nanotubes, including carbon nanotubes, where the nanotubes are single-walled nanotubes (SWNT), multiwalled nanotubes (MWNT), or combinations of these; fullerenes, nanographite, or combinations thereof. Many suitable carbonaceous (such as graphitic) core materials subjected to the process according to the present disclosure are commercially available, and can be employed in the processes of the invention. Also included as a possible starting material are surface-modified carbonaceous materials as described herein above.

In certain embodiments of this aspect of the disclosure, the carbonaceous material is natural or synthetic graphite.

The process can also generally be carried out with carbonaceous particles with an average size of more than 1 μm, and up to 1000 μm (or even more). For instance, the carbonaceous starting material will have a PSD with a D₅₀ of between about 2 and 500 μm, or between about 5 and 500 μm, or between about 5 and 200 μm, or between about 5 and 100 μm.

In some embodiments of this aspect, the process for making the NPSM carbonaceous particles includes the deposit of nanoparticles on the surface of carbonaceous particles in a plasma reactor. The process for attaching the nanoparticles to the surface of the carbonaceous particles can in these embodiments be characterized as a plasma polymerization process. In certain embodiments, the plasma polymerization process is a plasma enhanced chemical vapor deposition (PECVD) process.

The plasma reactor is for example a glow-discharge type reactor which can be operated at ambient temperature, i.e. such a reactor generates a so-called “cold plasma”. Thus, in some embodiments of this aspect the disclosure the process can be carried out at gas temperatures of between 0 and 200° C., for example at gas temperatures between 20 and 100° C., or 20 to 50° C., or even without any external heat source (e.g., essentially at room temperature).

When the process is carried out in a plasma reactor, the monomer being the source for the plasma-deposited nanoparticles is selected from
(i) hydrocarbons or a mixture of hydrocarbons, optionally having functional groups;
(ii) higher molecular weight organic molecules;
(iii) silicon compounds,
(iv) halogenated carbons, including fluorocarbons
(v) organometallic compounds,
(vii) tin compounds,
(viii) phosphorous compounds,
   or combinations thereof.

The hydrocarbons are for example selected from one or more of methane, ethane, ethylene, acetylene, propane, propylene, heavy oil, waste oil, pyrolysis fuel oil, or combinations thereof, while the organic molecules may comprise a vegetable fat such as rapeseed oil. Hydrocarbons may also include functional groups, i.e. oxygen, nitrogen, sulfur atoms may also be present. Halogenated carbon compounds may include chloro-, fluoro, and bromocarbons, including mixed halogencarbons (e.g. fluoro-chlorocarbons). Suitable fluorocarbons include, but are not limited to C₂F₆ or C₃F₈, whereas silicon compounds may include siloxanes and/or silanes, such as Hexamethyldisiloxane (HMDSO), Divinyltetramethyldisiloxane (DVTMDSO), or Triethylsilane (TES), amongst others. Examples of organometallic compounds include titanium(IV) isopropoxide, tetrakis dimethylamido titanium (TDMAT), tetrakis diethylamido titanium (TDEAT), diethylamino titanium (DEAT), dimethylaminotitanium (DMAT). Tin compounds may include tin-containing organic compounds. Titanium tetrachloride may also be used as a monomer in certain embodiments.

The plasma process in certain embodiments comprises the use of at least two, sometimes even three, four or more than four different monomers which are added to the plasma reactor. In some embodiments, one monomer is a hydrocarbon such as acetylene or ethylene, and another monomer is a siloxane, such as hexamethyldisiloxane (HMDSO), or a silane such as triethylsilane.

In some embodiments, the monomer added to the plasma reactor is in gaseous or liquid form. The feeding rate of the monomer is generally dependent on the specifications of the plasma reactor and the flow rate of the carrier gas (if present). In certain embodiments, the feeding rate of the gaseous monomer is typically between about 0.1 to 1 L/min, for example between 0.1 and 0.3 L/min.

The plasma deposition of nanoparticles in a plasma reactor according to the present disclosure is in some embodiments carried out in the presence of a carrier gas stream. Thus, in some embodiments the monomer is introduced into the reactor via a carrier gas stream. The carrier gas is typically an inert gas, such as argon, nitrogen, helium, xenon and the like. However, in some embodiments, especially for monomers in gaseous form, an additional carrier gas may not be required.

The amount of the monomer added to the plasma reactor is typically in the range of 1-10 vol. % (sccm, standard cubic centimeter per minute), for example in the range of 2-5 vol. % in relation to the system pressure.

In some embodiments, the powder particles is present in the plasma zone of the reactor together with the monomer. In certain embodiments, the carbonaceous particles are introduced into the reactor together with the monomer and the carrier gas, i.e. the plasma polymerization and deposition of the nanoparticles is carried out in the presence of the monomer and the substrate to be modified. In some embodiments, the process may be carried out in a reactor that allows the powderous carbonaceous substrate to be introduced at the top of the reactor, and allowing the particles to fall by gravity through the plasma zone in the presence of the monomer source. Such a setup may be advantageous because it offers the possibility to carry out the process as a continuous process.

In some embodiments, the process is therefore a continuous process. In other embodiments, the process may also be carried out as a batch process.

In certain embodiments, the process is a one-step process wherein the particles to be coated are supplied together, or concomitantly, with the monomer source and, optionally, the carrier gas to the plasma region of the reactor, i.e. the core particles and precursor monomer compounds are not in contact prior to entering the plasma reactor. Accordingly, no pre-mixing of the monomer source and the particles to be coated is required in such a setup.

The gas stream in the plasma reactor is in some embodiments guided through a plasma zone, in which an electric gas discharge is used for the production of a non-isothermal plasma, especially for the generation of free charge carriers and excited neutral species, wherein the gaseous monomer serving as a starting material for the formation of the nanoparticles, is admixed to the gas stream before or in the plasma zone, and wherein the free charge carriers and excited neutral species are used directly in the plasma zone the plasma zone, in order to bring the gaseous monomer into a chemically reactive state and to a homogenous chemical reaction, such that nanoparticles are formed by chemical separation from the gaseous phase. In this process, nanoparticles are attached to the surface of the carbonaceous particles, presumably by the collision of the two particle types in a treatment zone through which a carbonaceous particle- and/or gas-carbonaceous particle stream is guided under the influence of the gas stream and/or gravity. In some embodiments, the nanoparticles may also grow in size after being attached to the surface of the carbonaceous particles to be treated in the plasma reactor.

In certain embodiments, a microwave coupling, a middle- or high frequency coupling or DC-excitation is used for the generation of an electric gas discharge in the plasma reactor. The plasma zone contains in some embodiments a non-isothermal low pressure plasma or a normal pressure plasma. For example, when carried out with low pressure plasma, said plasma is operated at a pressure in the range of 0.2 mbar to 4 mbar.

The process is in some embodiments operated in a tubular inductively-coupled RF plasma reactor as shown in FIG. 1.

Although it will again be appreciated that the discharge power range depends on the specifications and dimensions of the plasma reactor, the process described herein is in some embodiments operated with a plasma discharge power of between about 100 and about 2000 W, between about 200 to about 1500 W, for example between about 500 and about 1200 W. In other embodiments, a discharge power of between 100 and 700 W was used for the process.

Generally, the residence time of the carbonaceous particles in the plasma reactor may vary and is dependent on the reactor type, as well as on certain process parameters, such as mean gas velocity (which is itself dependent on parameters such as the flow rate of the monomer/carrier gas mixture). In some embodiments, the residence time of the particles may be relatively short, i.e. in the sub-second range. For example, the residence time of the graphite particles in the tubular inductively-coupled RF plasma reactor (cf. FIG. 1) was in the range of 0.05 to 0.5 seconds, e.g. about 0.1. seconds.

For plasma reactors of the type described in more detail herein, the powder residence time can be calculated from certain process parameters, as described in detail in the Methods section, infra.

For example, with a gas flow rate of 500 sccm (0.0000083 m³/s) and a system pressure of 1.5 mbar, the powder residence time was calculated to be about 0.11 s.

Further details about the calculation of the residence time and other aspects of plasma polymerization can for example be found in C. Roth, Ph.D. Thesis No. 20812, ETH Zurich, 2012, and H. Yasuda, Plasma Polymerization, Academic Press Inc., FL, USA (1985).

Further details, process parameters and modifications of the process are described in EP 1 928 597 B, which is incorporated herein by reference in its entirety.

The process may in some embodiments further comprise a subsequent surface modification, such as surface oxidation or coating with an amorphous carbon, or both, as described hereinabove with reference to WO 2013/149807, WO 2015/158741 or WO 2016/008951 whose methods are likewise incorporated herein by reference in their entirety.

### Surface-Modified Carbonaceous Material Prepared According to the Present Invention

Another aspect of the present invention is related to the nanoparticle surface-modified carbonaceous material as defined herein obtainable by any of the processes described herein.

### Methods for Improving Certain Properties of Carbonaceous Materials

As noted above, the present disclosure further relates to methods for improving technically relevant properties of carbonaceous particles. In one aspect, the present disclosure relates to a method for improving the flowability of carbonaceous particles which comprises the deposition of nanoparticles on the surface of said carbonaceous material in accordance with a process as described herein.

Another aspect covered by the present disclosure relates to a method for increasing the apparent (Scott) and/or tap density of carbonaceous particles which comprises the deposition of nanoparticles on the surface of said carbonaceous material in accordance with a process as described herein.

Yet another aspect relates to a method for increasing the dosing accuracy of a given carbonaceous, e.g. graphitic, material in particulate form which comprises the deposition of nanoparticles on the surface of said carbonaceous material in accordance with a process as described herein.

In a further aspect, the present disclosure relates to methods for providing a pre-passivation layer on the surface of a negative electrode active material comprising natural or synthetic graphite, which comprises the deposition of nanoparticles on the surface of said graphite material in accordance with a process as described herein.

A further aspect of the present disclosure is a method for improving the irreversible capacity of a lithium ion battery, comprising the use of a NPSM carbonaceous particles as described herein as an active material in the negative electrode of the battery. In some embodiments the nanoparticles deposited on the surface of the carbonaceous particles comprise silicon, which may increase the electrochemical capacity of the battery above its theoretical value (for graphite).

In another aspect, the present disclosure relates to a method of improving the reversible capacity of a lithium ion battery, which comprises employing an NPSM carbonaceous particulate material as described herein as an active material in the negative electrode of the battery. In some embodiments of this aspect, the reversible capacity of such a battery is above about 350 mAh/g, or above about 380 mAh/g, or above about 400 mAh/g, or above about 425 mAh/g.

Yet another aspect relates to a method of improving the charge acceptance (also referred to as Coulombic efficiency) of a lithium ion battery, which comprises employing an NPSM carbonaceous particulate material as described herein as an active material in the negative electrode of the battery.

A further aspect of the present disclosure relates to the use of the NPSM carbonaceous particulate material as described herein for increasing the cycling stability of a lithium ion battery which comprises said NPSM carbonaceous particulate material as an active material in the negative electrode of the battery.

Another aspect of the invention relates to a method for improving the dispersibility of carbonaceous particles, which comprises attaching nanoparticles to the surface of the said carbonaceous particles. In some embodiments, the carbonaceous particles may have a platy morphology, for example natural or synthetic flaky graphite.

Yet another aspect of the invention is a method of increasing the interaction of particles with a matrix material, which comprises attaching interaction centers to the surface of the particles, wherein the interaction centers comprise nanoparticles.

### Compositions Comprising the Nanoparticle Surface-Modified Carbonaceous Material in Particulate Form

Another aspect of this invention relates to compositions comprising the nanoparticle surface-modified carbonaceous particles in a mixture together with other carbonaceous particles (including natural or synthetic graphite, carbon black, coke, and the like) or non-carbonaceous materials (e.g., metallic materials) in particulate form, or combinations thereof.

Yet another aspect of the present invention relates to a heat sink material comprising the nanoparticle surface-modified carbonaceous material as described herein.

Dispersions comprising a liquid and the NPSM carbonaceous material in particulate form as described herein form another aspect of the present invention. In some embodiments, the dispersion further comprises unmodified carbonaceous particles. Typically, the NPSM carbonaceous particles are present in an amount ranging from about 10 to 99 wt. % of a total amount of carbonaceous particles, or 20 to 90% of the total amount of carbonaceous particles, or 30 to 85 wt. % of the total amount carbonaceous particles. In certain embodiments of this aspect, the particles have an average particle size distribution with a D₅₀ ranging from 0.5 to 100 μm, or from 1 to 50 μm.

The dispersions may have a solids content that typically ranges from 1 to 90 wt. %, or from 10 to 70 wt. %, or from 20 to 55 wt. %. In some embodiments, the dispersions may further comprise stabilizers, dispersants, wetting agents, protective colloids, or combinations thereof.

Another aspect of the invention relates to a dispersion comprising carbonaceous particles and a matrix material, wherein the particles comprise interaction centers interacting with the matrix material, wherein the interaction centers comprise nanoparticles. In some embodiments, the matrix material may be a polymer, a fluid, or both.

### Other Aspects

Another aspect of the invention relates to carbonaceous particles that exhibit an improved flowability, expressed by the flowability factor ff_{c}, wherein the flowability factor ff is at least 3.5, for example at least 4.0, 5.0, 6.0, 7.0, 8.0, 9.0 or 10.0. In some embodiments, the carbonaceous particles have a platy morphology. These carbonaceous particles may in some embodiments be further characterized by any one of the parameters outlined herein, alone or in combination.

Yet another aspect of the invention is directed to platy particles per se which have an improved flowability, expressed by a flowability factor ff_{c}, of at least 3.5, for example at least 4.0, 5.0, 6.0, 7.0, 8.0, 9.0 or 10.0. In this aspect, some embodiments may relate to carbonaceous particles, and some embodiments may relate to non-carbonaceous particles. These carbonaceous particles may optionally be further characterized by any one of the parameters outlined herein, alone or in combination.

### Measurement Methods

The percentage (%) values specified herein are by weight, unless explicitly specified otherwise.

### Specific BET Surface Area

The method is based on the registration of the absorption isotherm of liquid nitrogen in the range p/p0=0.04-0.26, at 77 K. The nitrogen gas adsorption is performed on a Quantachrome Autosorb-1. Following the procedure proposed by Brunauer, Emmet and Teller (Adsorption of Gases in Multimolecular Layers, J. Am. Chem. Soc., 1938, 60, 309-319), the monolayer capacity can be determined. On the basis of the cross-sectional area of the nitrogen molecule, the monolayer capacity and the weight of sample, the specific surface can then be calculated. The isotherm measured in the pressure range p/p0 0.01-1, at 77 K are measured and processed with DFT calculation in order to assess the pore size distribution, micro- and mesopore volume and area.

### REFERENCES

Ravikovitch, P., Vishnyakov, A., Russo, R., Neimark, A., Langmuir 16 (2000) 2311-2320; Jagiello, J., Thommes, M., Carbon 42 (2004) 1227-1232.

### Particle Size Distribution by Laser Diffraction

The presence of particles within a coherent light beam causes diffraction. The dimensions of the diffraction pattern are correlated with the particle size. A parallel beam from a low-power laser lights up a cell which contains the sample suspended in water. The beam leaving the cell is focused by an optical system. The distribution of the light energy in the focal plane of the system is then analyzed. The electrical signals provided by the optical detectors are transformed into the particle size distribution by means of a calculator. The method yields the proportion of the total volume of particles to a discrete number of size classes forming a volumetric particle size distribution (PSD). The particle size distribution is typically defined by the values D₁₀, D₅₀ and D₉₀, wherein 10 percent (by volume) of the particle population has a size below the D₁₀ value, 50 percent (by volume) of the particle population has a size below the D₅₀ value and 90 percent (by volume) of the particle population has a size below the D₉₀ value.

The particle size distribution data by laser diffraction quoted herein have been measured with a MALVERN Mastersizer S. For determining the PSD, a small sample of a carbon material is mixed with a few drops of wetting agent and a small amount of water. The sample prepared in the described manner is introduced in the storage vessel of the apparatus (MALVERN Mastersizer S) and after 5 minutes of ultrasonic treatment at intensity of 100% and the pump and stirrer speed set at 40%, a measurement is taken.

### REFERENCES

ISO 13320 (2009)/ISO 14887

### Oil Absorption Number

Sample powder is blended into a large variety of systems where absorption is an important parameter. The oil test is a means to determine the general behaviour of materials in this respect. A slow filter paper is placed into a special centrifuge metal tube having an inner diameter of 13.5 mm and a sieve on the bottom (18 mesh). In order to wet the filter, 0.5 g of paraffinic oil is filled into the tube and centrifuged for 30 minutes at 521 g (1 g=9.81 m/s², corresponding to 1500 rpm in the Sigma 6-10 centrifuge). After the wetting procedure, the tube is weighed and 0.5 g of graphite powder is added. The graphite is covered with 1.5 g of paraffinic oil and centrifuged for 90 minutes at 521 g. After centrifuging, the tube is weighed. The oil absorption per 100 g of graphite powder is calculated on the basis of the weight increase.

### Raman Spectroscopy

Raman analyses were performed using LabRAM-ARAMIS Micro-Raman Spectrometer from HORIBA Scientific with a 632.8 nm HeNe LASER. The ratio I_{D}/I_{G} is based on the ratio of intensities of the so-called band D and band G. These peaks are measured at 1350 cm⁻¹ and 1580 cm⁻¹, respectively, and are characteristic for carbon materials.

### Crystallite Size Lₐ

Crystallite size Lₐ may be calculated from Raman measurements using equation:

Lₐ[Angstrom]=C×(I_{G}/I_{D})

where constant C has values of 44[Å] and 58[Å] for lasers with wavelength of 514.5 nm and 632.8 nm, respectively. I_{G} and I_{D} are the intensities of the D- and G-band Raman absorption peaks at around 1350 cm⁻¹ and 1580 cm⁻¹, respectively.

### X-Ray Diffraction

XRD data were collected using a PANalytical X′Pert PRO diffractometer coupled with a PANalytical X'Celerator detector. The diffractometer has following characteristics shown in Table 1:

TABLE 1
Instrument data and measurement parameters

| | |
|---|---|
| Instrument | PANalytical X′Pert PRO |
| X-ray detector | PANalytical X′Celerator |
| X-ray source | Cu-K_{α} |
| Generator parameters | 45 kV-40 mA |
| Scan speed | 0.07°/s (for L_{c} and c/2) |
| | 0.01°/s (for [004]/[110] ratio) |
| Divergence slit | 1° (for L_{c} and c/2) |
| | 2° (for [004]/[110] ratio) |
| Sample spinning | 60 rpm |

The data were analyzed using the PANalytical X′Pert HighScore Plus software.

### Interlayer Spacing c/2

The interlayer space c/2 was determined by X-ray diffractometry. The angular position of the peak maximum of the (002) reflection profiles were determined and, by applying the Bragg equation, the interlayer spacing was calculated (Klug and Alexander, X-ray diffraction Procedures, John Wiley & Sons Inc., New York, London (1967)). To avoid problems due to the low absorption coefficient of carbon, the instrument alignment and non-planarity of the sample, an internal standard, silicon powder, was added to the sample and the graphite peak position was recalculated on the basis of the position of the silicon peak. The graphite sample was mixed with the silicon standard powder by adding a mixture of polyglycol and ethanol. The obtained slurry was subsequently applied on a glass plate by meaning of a blade with 150 μm spacing and dried.

### Crystallite Size L_{c}

Crystallite size was determined by analysis of the [002] diffraction profile and determining the widths of the peak profiles at the half maximum. The broadening of the peak should be affected by crystallite size as proposed by Scherrer (P. Scherrer, Göttinger Nachrichten 2, 98 (1918)). However, the broadening is also affected by other factors such X-ray absorption, Lorentz polarization and the atomic scattering factor. Several methods have been proposed to take into account these effects by using an internal silicon standard and applying a correction function to the Scherrer equation. For the present invention, the method suggested by Iwashita (N. Iwashita, C. Rae Park, H. Fujimoto, M. Shiraishi and M. Inagaki, Carbon 42, 701-714 (2004)) was used. The sample preparation was the same as for the c/2 determination described above.

### Xylene Density

The analysis is based on the principle of liquid exclusion as defined in DIN 51 901. Approx. 2.5 g (accuracy 0.1 mg) of powder is weighed in a 25 ml pycnometer. Xylene is added under vacuum (15 Torr). After a few hours dwell time under normal pressure, the pycnometer is conditioned and weighed. The density represents the ratio of mass and volume. The mass is given by the weight of the sample and the volume is calculated from the difference in weight of the xylene filled pycnometer with and without sample powder.

### REFERENCE

DIN 51 901

### Apparent Density by the Scott Volumeter

The Scott density is determined by passing the dry carbon powder through the Scott volumeter. The powder is collected in a 1 in³ vessel (corresponding to 16.39 cm³) and weighed to 0.1 mg accuracy. The ratio of weight and volume corresponds to the Scott density. It is necessary to measure three times and calculate the average value.

### REFERENCE

ASTM B 329-98 (2003)

### Tap(Ped) Density

100 g of dry graphite powder was carefully poured into a graduated cylinder. Subsequently, the cylinder is fixed on the off center shaft-based tapping machine and 1500 strokes are run. The reading of the volume is taken and the tap density is calculated.

### REFERENCE

DIN-ISO 787-11

### Pressed Density

A defined amount of graphite powder was poured into a die. After inserting the punch and sealing the die, compression force is applied. After ejection of the test bar dimensions (W×L×H) were taken. Pressed density is calculated as the ratio of mass to volume.

### Scanning Electron Microscopy (SEM)

The particle surface of the carbonaceous material was imaged using a scanning electron microscope (Zeiss Leo 1530 SEM) equipped with a stub specimen holder, where the carbonaceous material is fixed by means of conductive stickers. An incident electron beam is focused under vacuum (10⁻³ Pa) on the specimen and gives place to secondary-electron emission, together with backscattered electrons and emitted X-rays. The secondary-electron signals revealed by a detector permits the topographical mapping of the specimen surface with a maximum magnification of the order of 100 kx and a maximum resolution of the order of 1 nm.

The microscopy conditions employed for the imaging of c were 10.0 kV electron-acceleration voltage, 30 μm aperture size, in-lens image mode, and 250 kx magnification.

### Spark Discharge Optical Emission Spectroscopy (SD OES)

This analysis was performed by an SDAR OES Simultaneous Emission Spectrometer (Optical emission spectrometer (OES) with spark discharge in argon: ARL Spectrometer 3460). Carbonaceous powder is, if necessary, ground to a maximum particle size of 80 μm by means of a vibrated mill, e.g. a NAEF mill with a wolfram carbide container. Following the (optional) milling, the sample is passed through a screen (e.g. 0.5 mm) in order to remove any agglomerates or particles that have not been milled to the fineness required. Subsequently, the powder is compacted into a pressed pellet, for example by means of a Herzog Press.

### Preparation of a Pressed Pellet (Using the Herzog Press):

After having placed a clean cardboard paper at the bottom of the pressing tool, about 6 g of the sample to be analysed was filled into the at least 20 mm diameter round pressing die; a second clean cardboard paper was carefully put on top of the sample. The upper cylinder was lowered and pressure was applied until the manometer indicates 20 tons. The pressure was applied for at least 30 seconds; the pressure was then released and the sample removed, still with both sided protected by the cardboard paper. The sample (now in the form of a pellet) was now ready for analysis.

### Spectrometric Analysis

The sample was placed onto the excitation stand under argon atmosphere of the spectrometer. Subsequently the fully automatic analysis (software of the spectrometer manufacturer) was initiated. The analysis was repeated (the sample pellet is rotated each time) until a repeatable analysis result was obtained.

The instrument was calibrated with an internal standard that has been analysed by external accredited laboratories.

### REFERENCE

K. Slickers, Automatic Emission Spectroscopy, Brühl, Druck und Presshaus Giessen (D) (1992)

### X-Ray Photoelectron Spectroscopy (XPS)

Elemental composition and speciation of the surface of the tested carbonaceous material were determined with an X-Ray Photoelectron Spectrometer (SIGMA Probe II XPS) equipped with an ALPHA 110 hemispherical electron energy analyzer (110 mm mean radius). The specimen was placed and pressed by means of aluminum papers into bowl-shaped aluminum sample holders (6 mm diameter) without any sticker. A Mg Kα X-ray source (1253.6 eV) operating at 200 W was used for irradiating the specimen under vacuum (<10⁻⁷ Pa). The intensity and the kinetic energy of the emitted photoelectrons revealed by the electron analyzer give information about the chemical nature of the atoms present on the surface. Specimen emission angle and source-to-analyzer angles were respectively 0° and 50°, lens mode was large-area XPS, dwell time and energy step size were respectively 50 ms and 0.1 eV. The analyzer was operated in the fixed analyzer transmission mode, with pass energy set at 50 eV for the acquisition of the survey spectra (9 scans averaged) and at 20 eV for the acquisition of the high-resolution spectra (27 scans averaged).

The acquired XPS spectra were referenced to the aliphatic carbon C1s signal at 285.0 eV and fitted by means of CASAXPS software with Gaussian-Lorentzian line shape, after Shirley background subtraction. All fitting parameters were constrained except the peak intensity, and the binding energies of the signal components were assigned according to literature¹. The quantitative analysis was performed for C1s signal, O1s signal and Si2p3/2 signal by considering the peak areas in the high-resolution spectra, which were corrected for Scofield's photoionization cross sections, asymmetry function, attenuation length, and analyzer transmission function^{2,3,4,5}. The relative sensitivity factors calculated for C1 s signal, O1s signal and Si2p3/2 signal were respectively 1.00, 3.30 and 0.52. The maximum uncertainty of the measured binding energies equal to 0.2 eV 6.

### REFERENCES

1. G. E. Mullelberg (Ed.), Handbook of X-ray Photoelectron Spectroscopy, Perkin-Elmer Corporation (Physical Electronics Division), Eden Prairie, Minn., 1978.
2. J. H. Scofield, J. Electron Spectrosc. Relat. Phenom. 1976, 8, 129.
3. R. F. Reilman, A. Msezane, S. T. Manson, J. Electron Spectrosc. Relat. Phenom. 1976, 8, 389.
4. M. P. Seah, W. A. Dench, Surf. Interface Anal. 1979, 1, 2.
5. K. Berresheim, M. Mattem-Klosson, M. Wilmers, Fresenius J. Anal. Chem. 1991, 341.
6. S. Hofmann, Auger- and X-Ray Photoelectron Spectroscopy in Materials Science, Springer-Verlag, Heidelberg, D, 2013.

### Mean Particle Residence Time

The mean particle residence time Tp of the carbonaceous particles in a plasma reactor is calculated according to the following equation:

$${τ}_{P} = \frac{L}{{v}_{g}}$$

v_{g}=mean gas velocity at the reactor tube inlet, L=total plasma length (typically equal to the reactor length, e.g. 0.5 m). This formula assumes that the powder particles introduced into the reactor are accelerated to the mean gas velocity at the reactor tube inlet. The mean gas velocity is related to gas flow rate and system pressure as follows:

$${v}_{g} = \frac{F}{{Ap}_{atm}}$$

where F is the gas flow rate, A is the area of the reactor section (whose diameter is for example 0.04 m), pₐₜₘ is the system pressure in [atm].

### Flowability Measurements

The powder flow behavior (flowability) depends on the balance of the forces acting on the powder particles. For dry micropowders the prevailing forces are the Van-der-Waals attractive interparticle forces, which are strongly influenced by the surface roughness (I. Zimmermann, M. Ebner, K. Meyer, Z. Phys. Chem. (2004), 218, 51). The flowability is quantified by the following factor:

$${ff}_{c} = \frac{{σ}_{1}}{{σ}_{c}}$$

which is defined as the ratio of the consolidation stress σ₁ to the unconfined yield strength σ_{c} in an uniaxial compression test (see FIG. 2). First, the powder is totally confined and compressed by the consolidation stress σ₁. After σ₁ is released and the confinement is removed, an increasing stress is applied until the powder breaks apart and flows. This critical stress is ac, which increases with increasing consolidation stress. The flow function is the relationship between σ₁ and σ_{c} and its slope is the flow function coefficient ff_{c}. The flow behaviour is classified as “not flowing” for ff_{c}<1, “very cohesive” for 1<ff_{c}<2, “cohesive” for 2<ff_{c}<4, “easy-flowing” for 4<ff_{c}<10, and as “free-flowing” for 10<ff_{c} 2 (cf. C. Roth, Ph.D. Thesis No. 20812, ETH Zurich, 2012, and D. Schulze, Powders and bulk solids-behavior, characterization, storage and flow, Springer, Germany, 2008).

The ff_{c} of the carbonaceous material was measured by means of a ring shear tester (RST-XS Schulze Schüttguttechnik, Germany). The powder was filled into a 30 ml annular shear cell (FIG. 3) and covered with an annular lid. A pre-shear stress is applied on the lid to consolidate the powder, then the sample is sheared by rotating the shear cell. The torque at the lid is measured until the critical shear stress is reached, where the transition from elastic to plastic deformation occurs. This is repeated for several consolidation stresses to obtain multiple shear points. The sample is pre-sheared before each measurement to reach a uniform consolidation of the powder. All shear points lie on the so-called yield locus. This line and the pre-shear point at steady flow are used to calculate the major principal stress σ₁ and the unconfined yield strength σ_{c} and thus to determine the flow function coefficient (cf. D. Schulze, Powders and bulk solids—behavior, characterization, storage and flow, Springer, Germany, 2008). For the experiments described herein, the pre-shear stress was set to 5000 Pa and shear stresses of 1000, 2500 and 4000 Pa were applied to determine ff_{c}.

### Powder Electrical Resistivity/Conductivity

For determining the electrical conductivity of a carbonaceous particulate material, the sample was weighted and compressed inside an insulating mould (a ring made of glass fiber reinforced polymer having an inner diameter of 11.3 mm and inserted in a larger ring made of steel for additional mechanical support) between a piston and an anvil, both made of brass and of cylindrical shape (diameter: 11.3 mm). The applied force was controlled during the experiment, while the position of the piston relative to the position of the anvil was measured using a length gauge. The resistance of the sample was measured in situ during compression and pressure release at constant current (100 mA) using piston and anvil as the electrodes (2-point resistance measurement).

### REFERENCES

Probst, Carbon 40 (2002) 201-205
Grivei, K G K Kautschuk Gummi Kunststoffe 56. Jahrgang, Nr. September 2003
Spahr, Joumal of Power Sources 196 (2011) 3404-3413

### Electrochemical Measurements:

### Electrochemical Measurements

The carbonaceous sample slurries were manufactured with a rotation-revolution mixer (THINKY, ARE-310), in a mass ratio of 98:1:1 graphite, CMC (carboxymethyl cellulose) and SBR (styrene-butadiene rubber). The graphite electrodes, whose loading was controlled at 7-8 mg/cm², were manufactured by coating the slurry onto copper foil. All electrodes were pressed to 1.7 g/cm³.

The electrochemical measurements were performed in 2032 coin cells at 25° C. The cells were assembled in a glove box filled with Ar, using a lithium electrode (14 mm diameter, 0.1 mm thickness), a polyethylene separator (16 mm diameter, 0.02 mm thickness), 200 μL of electrolyte (1M LiPF₆ in EC:EMC 1:3 v/v) and a graphite electrode (14 mm diameter).

After assembly, measurements were performed with a potentiostat/galvanostat (MACCOR, MODEL 4000). The cells were charged to 5 mV at 0.1 C (a C-rate of 0.1 C means that a complete half-cycle is completed in 1/0.1=10 h), followed by a potentiostatic step until the current dropped to 0.005 C, and then discharged to 1.5 V at 0.1 C. The capacity (specific charge) measured during discharge was defined as the reversible capacity. The difference between the capacity measured during charging and the reversible capacity was defined as the irreversible capacity, and the coulombic efficiency, which is defined as a percentage, was calculated by dividing the reversible capacity by the capacity measured during charging.

After adjusting the SOC to 50%, each coin cell was opened and the graphite electrode was reassembled into a new cell together with another graphite electrode that was also at 50% SOC. The obtained symmetric cells, whose voltage should be exactly 0 V, were connected to the potentiostat/galvanostat. The voltage after 20 s of discharge at 1 C divided by the current was defined as the electrode resistance.

As a measure of cycling stability, the capacity retention, which is expressed as a percentage and defined as the reversible capacity during the twelfth discharge divided by the reversible capacity during the second discharge, was calculated.

The high-current rate performance, which is expressed as a percentage, was calculated from the ratio of the reversible capacity measured at 2 C and 0.2 C discharge rate.

Having described the various aspects of the present invention in general terms, it will be apparent to those of skill in the art that many modifications and slight variations are possible without departing from the spirit and scope of the present invention. The following working examples further illustrate certain embodiments of the present invention.

### Examples

### Example 1—General Procedure for Plasma-Deposition of Nanoparticles

Plasma deposition of nanoparticles on the surface of graphite powder was carried out in a tubular inductively-coupled RF plasma reactor (cf. FIG. 1). The plasma was ignited in a glass tube cooled by deionized water. The plasma source consists of a radio-frequency (13.56 MHz) generator connected through an impedance matching network to a water-cooled copper coil. Prior to introducing the feed gas, the reactor was evacuated to 3 Pa pressure with a vacuum-pump system, then the feed gas was supplied and the system pressure was set, as described in more detail in C. Roth, Z. Kuensch, A. Sonnenfeld, P. Rudolf von Rohr, Surface & Coating Technology (2011), 205, p. 597.

Once a stable plasma had been established, a synthetic graphite powder (Synthetic Graphite No. 1, or SG-1), with a particle size distribution (PSD), as determined by laser diffraction, characterized by a D₁₀ of about 7 μm, a D₅₀ of about 15 μm and a D₉₀ of about 30 μm, a BET SSA of about 8-9 m²/g, and a Scott (i.e. tap) density of about 0.23 g/cm³) was fed into the reactor from a storage tank with a screw powder feeder at a rate of 1.6 Kg/h for 5 minutes. The powder was mixed with the feed gas in a conical nozzle and its residence time in the reactor was on the order of 0.1 s. Below the plasma zone the powder particles were separated from the gas stream by a down corner, cyclone and filter unit and collected in vessels.

Experiments were carried out with the same graphite material (Synthetic Graphite No. 1, or SG-1), but varying the monomer source (acetylene, HMDSO, both), the system pressure and plasma power, in the presence or absence of carrier gas such as argon.

TABLE 1a
Process Conditions for Surface-Modification of Synthetic
Graphite (Plasma-Deposition of Nanoparticles)

| | Excitation | Additional | | System | Plasma |
|---|---|---|---|---|---|
| | gas | gas | Monomer | pressure | power |
| Sample | (sccm) | (sccm) | (sccm) | (mbar) | (W) |
| SG-1 | — | — | — | — | |
| (Starting | | | | | |
| Material) | | | | | |
| | Argon | | Acetylene | | |
| GR178 | 250 | | 250 | 1.50 | 800 |
| | Argon | | HMDSO | | |
| GR68 | 250 | | 250 | 2.50 | 1000 |
| | Argon | Acetylene | HMDSO | | |
| GR67 | 250 | 125 | 125 | 2.50 | 1000 |
| | | Acetylene | HMDSO | | |
| GR69 | | 250 | 250 | 2.50 | 1000 |
| | Argon | Acetylene | DVTMDSO | | |
| GR77 | 250 | 125 | 125 | 2.50 | 1000 |
| | Argon | | TES | | |
| GR168 | 250 | | 250 | 1.50 | 1000 |

The resulting surface-modified graphite was examined by SEM, and was characterized in terms of its BET SSA, SD-OES, XPS, tap density, and flowability factor. The results are summarized in the following table.

TABLE 1b
Characterization of Nanoparticle Surface-Modified Graphite

| | | | | Flowability factor | | XPS analysis | |
|---|---|---|---|---|---|---|---|
| | BET SSA | SD-OES | | RST-XS | | Sigma Probe | |
| | TRISTAR 3000 | [wt %] | Tap density | [-] | | Atomic ratio (surface) [-] | |
| Sample | (m²/g) | Si | [g/cm³] | | Std. dev. | O/C | Si/C |
| SG-1 | 7.8 | — | 0.57 | 3.4 | 0.1 | 0.02 | 0 |
| (starting | | | | | | | |
| material) | | | | | | | |
| GR178 | | | | 8.9 | 0.2 | 0.04 | 0 |
| GR68 | 7.1 | 0.5 | 0.7 | 10.3 | 0.0 | 0.10 | 0.43 |
| GR67 | 8.3 | 0.5 | 0.68 | 11.1 | 0.8 | 0.14 | 0.42 |
| GR69 | 7.0 | 0.5 | 0.71 | 9.1 | 0.8 | 0.14 | 0.38 |
| GR77 | 8.6 | 0.6 | 0.7 | 10.4 | 0.4 | 0.11 | 0.33 |
| GR168 | | | | 10.5 | 0.0 | 0.13 | 0.56 |

In addition, the electrical resistivity of the Nanoparticle Surface-Modified Graphite (by Plasma-Deposition) and Control Samples was determined. The results for two NPSM graphite powders and several control samples (untreated synthetic graphite powders) are shown in FIG. 6. As can be seen from the resistivity curves at varying density, the electrical resistivity of the NPSM graphite material is generally higher than of the corresponding untreated material.

In a further experiment, the pressure needed to achieve a certain pressed density of the carbonaceous material was determined for two nanoparticle surface-modified graphite powder samples according to the present disclosure, and of control samples (untreated material) was recorded. The results are shown in FIG. 7.

1. A surface-modified carbonaceous material in particulate form, wherein the surface-modified carbonaceous particles comprise a carbonaceous core and nanoparticles attached to the surface of the carbonaceous particles.

2. The surface-modified carbonaceous material according to claim 1, wherein the carbonaceous core comprises a material selected from natural or synthetic graphite, exfoliated graphite, carbon black, petroleum- or coal-based coke, graphene, graphene fiber; nanotubes, including carbon nanotubes, where the nanotubes are single-walled nanotubes (SWNT), multiwalled nanotubes (MWNT), or combinations of these; fullerenes, nanographite, or combinations thereof.

3. The carbonaceous material according to claim 1, wherein the nanoparticles on a surface of the carbonaceous particle comprise carbon, silicon, oxygen, fluorine, hydrogen, tin, titanium or combinations thereof.

4. The surface-modified carbonaceous material of claim 1, wherein at least two different nanoparticle species are present on the surface of the carbonaceous core particles.

5. The surface-modified carbonaceous material according to claim 1, wherein the nanoparticles on the surface of the carbonaceous particle are in the form of a polymer or a plasma polymer.

6. The surface-modified carbonaceous material according to claim 1, wherein the nanoparticles on the surface of the carbonaceous particle are plasma-deposited nanoparticles.

7. The surface-modified carbonaceous material according to claim 6, wherein the source monomer for the plasma-deposited nanoparticles is selected from
(i) methane, ethane, ethylene, acetylene, propane, propylene, heavy oil, waste oil, pyrolysis fuel oil, other hydrocarbon, or combinations thereof;
(ii) a vegetable fat, rapeseed oil, or other organic molecule;
(ii) a siloxane, a silane, hexamethyldisiloxane (HMDSO), divinyltetramethyldisiloxane (DVTMDSO), triethylsilane (TES), or other silicon compound
(iv) C₂F₆ C₃F₈, or other halogenated carbon;
(v) organometallic compounds,
(vi) titanium tetrachloride;
(vii) tin compounds;
(viii) phosphorous compounds; or
(iv) combinations thereof.

8. The surface-modified carbonaceous material according to claim 1, wherein the plasma-deposited nanoparticles consist essentially of carbon, optionally with low amounts of hydrogen, nitrogen, oxygen and/or sulfur.

9. The surface-modified carbonaceous material according to claim 7, wherein the plasma-deposited nanoparticles essentially consist of silicon, optionally with low amounts of hydrogen, carbon, nitrogen, oxygen, and/or sulfur.

10. The surface-modified carbonaceous material according to claim 7, comprising first and second species of plasma-deposited nanoparticles, wherein the first species essentially consists of carbon, optionally with low amounts of hydrogen, nitrogen, oxygen and/or sulfur, and the second species consists essentially of silicon, optionally with low amounts of hydrogen, carbon, nitrogen, oxygen, and/or sulfur.

11. The surface-modified carbonaceous material according to claim 6, wherein the source monomer for the plasma-deposited nanoparticles comprises a siloxane, a silane, hexamethyldisiloxane (HMDSO), divinyltetramethyldisiloxane (DVTMDSO), triethylsilane (TES), or other silicon compound and wherein the bulk content of silicon, as measured by Spark Discharge Optical Emission Spectroscopy (SD-OED), is at least about 0.30 wt %, for example at least about 0.40, or 0.50 wt %.

12. The surface-modified carbonaceous material according to claim 6, wherein the source monomer for the plasma-deposited nanoparticles comprises a siloxane, a silane, hexamethyldisiloxane (HMDSO), divinyltetramethyldisiloxane (DVTMDSO), triethylsilane (TES), or other silicon compound and wherein the atomic ratio of silicon to carbon (Si/C) on the surface of the carbonaceous particles, as measured by X-ray photoelectron spectroscopy (XPS), is at least about 0.25.

13. The carbonaceous material according to claim 12, wherein the atomic ratio of oxygen to carbon (O/C) on the surface of the carbonaceous particles, as measured by X-ray photoelectron spectroscopy (XPS), is at least about 0.3.

14. The surface-modified carbonaceous material according to claim 1, having a flowability factor ff of at least 3.5.

15. The surface-modified carbonaceous material according to claim 1, wherein the carbonaceous material comprising nanoparticles on the surface of the carbonaceous particles has a flowability factor ff_{c} that is at least about 50% higher than the flowability factor of the carbonaceous particles being devoid of said nanoparticles on the surface of the carbon particles.

16. The surface-modified carbonaceous material according to claim 1, having an apparent (Scott) density and/or tap density that is increased by about 10% compared to the tap density of the carbonaceous particles being devoid of said nanoparticles on the surface of the carbon particles.

17. The surface-modified carbonaceous material according to claim 1, further characterized by one or more of the following parameters, alone or in any combination:
a. a crystallite size L_{c} (L_{c}(002) as measured by XRD) ranging from 1 to 1000 nm;
b. a crystallite size Lₐ (as measured by Raman spectroscopy) from 1 to 1000 nm;
c. a ratio of L_{c}/Lₐ of between 0.1 and 1000;
d. a c/2 interlayer distance of between 0.3354 nm and 0.5000 nm;
e. a BET SSA of between about 0.5 m²/g and 800 m²/g;
f. a particle size distribution (PSD) expressed by a D₉₀ of below about 100 μm;
g. the nanoparticles representing from 1 to 50% (w/w) of the surface-modified carbonaceous particles; and
h. an oil absorption number below about 1000 (ml/100 g).

18.-44. (canceled)

45. A surface-modified carbonaceous material in particulate form, wherein the surface-modified carbonaceous particles comprise a carbonaceous core and nanoparticles attached to the surface of the carbonaceous particles, and
a. wherein the nanoparticles on the surface of the carbonaceous particle are plasma-deposited nanoparticles;
b. wherein the nanoparticles on the surface of the carbonaceous particle are in the form of a polymer, for example a plasma polymer;
c. wherein the surface-modified carbonaceous material in particulate form has a flowability factor ff_{c} of at least 3.5;
d. wherein the surface-modified carbonaceous material in particulate form has a flowability, expressed by the flowability factor ff_{c}, that is at least about 100% higher than the flowability factor of the carbonaceous particles being devoid of said nanoparticles on the surface of the carbon particles; or
e. wherein the surface-modified carbonaceous material in particulate form has a Scott and/or tap density that is increased by at least about 10%, compared to the respective density of the carbonaceous material in particulate form being devoid of said plasma-deposited nanoparticles on the surface of the carbon particles.

46. A composition comprising the nanoparticle surface-modified carbonaceous material in particulate form as defined in claim 1 in a mixture together with natural or synthetic graphite, exfoliated graphite, carbon black, coke, graphene, graphene fiber; nanotubes, including carbon nanotubes, where the nanotubes are single-walled nanotubes (SWNT), multiwalled nanotubes (MWNT), or combinations of these; fullerenes, nanographite, other carbonaceous materials, other carbonaceous materials in particulate form, or combinations thereof.

47-58. (canceled)

59. Cabonaceaous particles having improved flowability, expressed by the flowability factor ff_{c}, wherein the flowability factor ff_{c} is at least 3.5.

60. (canceled)

61. The surface-modified carbonaceous material according to claim 1, wherein the nanoparticles are attached to the surface by plasma enhanced chemical vapor deposition (PECVD).
